(19) United States
(12) Patent Application Publication
(10) Pub. No.: US 2026/0045755 A1
(43) Pub. Date: Feb. 12, 2026

(54) DELIVERING HIGH-POWER LASER PULSES

(71) Applicant: DAS-NANO TECH, S.L., TAJONAR (ES)

(72) Inventors: MIKEL SUBIZA GARCÍA, TAJONAR (ES); ANDREA INÉS ORTIGOSA, TAJONAR (ES); MÓNICA CASTRILLO CUARTANGO, TAJONAR (ES); LUIS MIRANDA SANTAFÉ, TAJONAR (ES); CRISTIAN MARTÍNEZ DE MORENTIN SUESCUN, TAJONAR (ES); ELENA TABOADA CABELLOS, TAJONAR (ES); EDUARDO AZANZA LADRÓN, GORRAIZ (ES); CARLOS LUMBRERAS SÁDABA, SESMA (ES); JON MIKEL PERCAZ CIRIZA, TAJONAR (ES); DAVID BENITO PERTUSA, PAMPLONA (ES); ISRAEL ARNEDO GIL, TAJONAR (ES)

(21) Appl. No.: 19/100,406

(22) PCT Filed: Sep. 7, 2022
(86) PCT No.: PCT/EP2022/074917

§ 371 Date: Jan. 31, 2025

(30) Foreign Application Priority Data
Aug. 3, 2022 (EP) 22382755.1

(51) Int. Cl. H01S 3/067; H01S 3/00; H01S 3/10

(52) U.S. Cl. CPC H01S 3/06754; H01S 3/0057; H01S 3/10046

(57) ABSTRACT

Delivery systems comprising pulse producer and first pulse supplier including first optical fiber path, first pulse amplifier and first delivering end. Pulse producer produces first low-power laser pulse having power predefined to avoid or minimize deformation of first low-power laser pulse. First pulse amplifier amplifies first low-power laser pulse to produce first high-power laser pulse having power predefined to operate first end-component connectable with first delivering end. First optical fiber path has initial section to convey first low-power laser pulse from pulse producer to first pulse amplifier, and final section to convey first high-power laser pulse from first pulse amplifier to first delivering end. First pulse amplifier is arranged at a position along first optical fiber path corresponding to distal position relative to pulse producer or proximal position relative to first delivering end. Methods and computer programs suitable for being performed by/at such delivery systems.

This application claims the benefit of European Patent Application EP22382755.1 filed 3 Aug. 2022.

The present disclosure relates to delivery systems for delivering one or more high-power laser pulses and, furthermore, to methods and computer programs of operating a delivery system for delivering one or more high-power laser pulses.

### BACKGROUND

An optical fiber is a glass thread, which can transmit signals onto light waves. Signals may be pulses conforming messages modulated, or what is the same data information, transmitted from one location to another creating a fiber optic communication. Signals may also be a pulse or train of pulses of predefined characteristics that are delivered to endpoints for a large range of applications. These systems share the optical fiber physical path and hence the intrinsic problems of light propagation through that medium, such as attenuation, dispersion and non-linear effects. Their effects can reduce the amount of bandwidth in the case of communication applications and spoil the delivered pulse specs after a small number of meters in pulse delivering applications.

Delivery systems are known for delivering a pulse or pulses train to a delivering end (or endpoint) through an optical fiber path. Pulse requirements at the endpoint may include predefined power, duration and/or shape parameters, and the fulfilling of these requirements may be important to guarantee good system performance. If pulse duration is ultrashort (e.g., in the range of picoseconds or femtoseconds) dispersion and non-linear effects may have detrimental effects and, hence, this may result in bad performance of the system. As the length of the optical fiber through which pulses are to convey increases, the fulfilling of delivering end's minimal requirements or specs may become more difficult.

Radiation-based (e.g., THz-based) measuring systems or the like are a suitable solution to, e.g., accurately determine thicknesses of multilayer materials in a non-contact and non-destructive way. Such a technology has proved to be very suitable in industrial applications, such as automotive, aerospace industry, etc. These systems may also be used to detect defects or imperfections other than thicknesses of materials such as, e.g., deformations, undue holes, discontinuities, etc.

Such radiation-based systems experience difficulties associated with propagation of ultrashort laser pulses in optical fibers over long distances because said long path to be traversed or travelled by said laser pulses may cause distortions in temporal shape and/or spectrum of the laser pulses. Therefore, radiation-based measuring requirements such as, e.g., accuracy/performance and laser transmission over long distances may be difficult to be met simultaneously.

An object of the disclosure is to provide new methods, systems and computer programs aimed at improving prior art manners of delivering high-power laser pulses.

### SUMMARY

In an aspect, delivery systems are provided for delivering one or more high-power laser pulses. Such delivery systems comprise a pulse producer and a first pulse supplier, the first pulse supplier including a first optical fiber path, a first pulse amplifier and a first delivering end. The pulse producer is configured to produce a first low-power laser pulse having a power predefined to avoid or minimize deformation of the first low-power laser pulse along the first pulse supplier. An initial section of the first optical fiber path is configured to convey the first low-power laser pulse from the pulse producer to the first pulse amplifier. The first pulse amplifier is configured to amplify the first low-power laser pulse to produce a first high-power laser pulse having a power predefined to operate a first end-component connectable with the first delivering end. A final section of the first optical fiber path is configured to convey the first high-power laser pulse from the first pulse amplifier to the first delivering end. The first pulse amplifier is arranged at a position along the first optical fiber path corresponding to a distal position relative to the pulse producer or proximal position relative to the first delivering end.

Minimizing deformation of a laser pulse may refer to the goal of causing predictable deformation of the pulse below a deformation threshold or within a deformation range. Amplification of a pulse may refer to causing power increasing of the pulse as required by end-component to be operated by the amplified pulse. For example, pulse amplifier may be configured to amplify the power of the low-power laser pulse between 5 and 20 times, between 10 and 20 times or whatever estimated necessary or convenient. Proximal and distal concepts are very well known in technical field(s) to which present disclosure relates. In line with said known concepts, proximal/distal position of the first pulse amplifier may be expressed as the first pulse amplifier being closer to the first delivering end than to the pulse producer or, in other words, initial section's length longer than final section's length. For example, initial and final sections of the first optical fiber path may have a length ratio of, e.g., 5/1, 4/1, 3/1, 2/1, 1.5/1 . . . n/1 (with n>1). Length ratio of n/1 may refer to that initial section's length is n′m and final section's length is 1*m, with m>=1. For example, length ratio of 5/1 may mean that initial section's length is 5 (5*1) or 10 (5*2) or 15 (5*3), etc. and final section's length is 1 (1*1) or 2 (1*2) or 3 (1*3), etc., respectively.

These delivery systems may operate much better than prior art systems aimed at same or similar purpose, because low-power laser pulse (or pulses train) traverses most of the optical fiber path and is amplified at a point of the optical fiber path proximal or close to delivering end. Low-power laser pulses have been proved to be less prone to distortions due to dispersion and/or nonlinear effects inherent to propagation through optical fiber and, accordingly, better quality high-power laser pulses may be finally delivered. The fact of amplifying low-power laser pulses at a final or almost final point of the optical fiber path permits high-power laser pulses to reach delivering end more accurately than prior art systems of same or similar type.

Delivery systems may further comprise a first pulse conditioner configured to modify or condition the first low-power laser pulse or the first high-power laser pulse or both to compensate for dispersion and/or non-linearity effects of the first pulse supplier. Dispersion and non-linearity effects may increase due to factors such as, e.g., long lengths, high pulse power, etc. The fact that low-power laser pulse (or pulses train) traverse most of the optical fiber path may reduce dispersion and non-linearity effects and, hence, may enable fulfilling delivering end's minimal requirements in a better way.

The first pulse conditioner may be included in the pulse producer or in the first pulse amplifier or in the first optical fiber path. In the case that the first pulse conditioner is comprised in the first optical fiber path, it may include an optical fiber portion with a dispersion parameter opposite to a dispersion parameter of all or part of remaining optical fiber in the first optical fiber path.

The initial section or the final section or both of the first optical fiber path have an oversized length for a plurality of intended (or even non-intended) applications of the delivery system. Such an oversized length may permit using delivery systems in different applications (with same or similar manufacturing specs) requiring more or less distance between pulse producer and first delivering end. Having an optical fiber path with oversized length provides great flexibility in terms of use of delivery systems disclosed herein, since same delivery system may be used for a plurality of applications requiring (very) different distances between pulse producer and delivering end. For example, delivery systems for different (and possibly divergent) applications may be configurationally uniformized, cheaper multi-purpose delivery systems may be designed and accordingly manufactured, etc. In examples, oversized optical fiber may be retractable and extensible, or rollable and unrollable, so that leftover optical fiber may be kept rolled or retracted which, when required or desired, may be unrolled or extended.

The initial section of the first optical fiber path may be extendable by including or aggregating therein a free dispersion fiber section which may include, e.g., fiber portions having dispersion parameters opposite to each other. If original length of the optical fiber path is not enough for a given application, optical fiber extensibility may add even more flexibility to delivery systems according to present disclosure, since said optical fiber extensibility may permit using the same delivery system for (even completely or substantially) unexpected applications requiring longer distances between pulse producer and delivering end. Implementations with such an optical fiber extensibility may imply connections or joins between different optical fiber portions, which may cause dispersion and non-linearity effects on laser pulse(s) or laser pulse train(s) when conveyed through said inter-joined optical fiber portions. The fact that, in delivery systems according to present disclosure, most of the optical fiber path (from pulse producer to almost delivering end) is traversed or travelled by low-power laser pulse(s) may be crucial in implementations with different optical fiber portions connected to each other. Since low-power pulses are much less affectable by dispersion and especially non-linearity effects than high-power pulses, delivery systems according to present disclosure with inter-joined optical fiber portions may be more easily and optimally implementable and, therefore, cheaper than in prior art delivery systems. With this kind of implementations, a pre-existing delivery system configured to operate with a given distance between pulse producer and delivering end may be adapted to operate with a longer distance between pulse producer and delivering end in very easier and cheaper manner.

In implementations, the first low-power laser pulse and the first high-power laser pulse may be a femtosecond or ultrashort laser pulse. Additionally or alternatively, the first low-power laser pulse and the first high-power laser pulse may have a wavelength of between 1500 nm and 1600 nm. Additionally or alternatively, all or part of the first optical fiber path may be polarization maintaining in order to, e.g., avoiding or minimizing possible polarization-related dispersion effects.

Delivery systems according to what may be denominated double-supply approach, may further comprise a second pulse supplier including a second optical fiber path, a second pulse amplifier and a second delivering end. In such a double-supply approach, the pulse producer may be further configured to produce a second low-power laser pulse having a power predefined to avoid or minimize deformation of the second low-power laser pulse along the second pulse supplier. An initial section of the second optical fiber path may be configured to convey the second low-power laser pulse from the pulse producer to the second pulse amplifier. The second pulse amplifier may be configured to amplify the second low-power laser pulse to produce a second high-power laser pulse having a power predefined to operate a second end-component connectable with the second delivering end. A final section of the second optical fiber path may be configured to convey the second high-power laser pulse from the second pulse amplifier to the second delivering end. Still in double-supply implementations, the second pulse amplifier may be arranged at a position along the second optical fiber path corresponding to a distal position relative to the pulse producer or proximal position relative to the second delivering end. The 10 second pulse supplier may have same configuration as the first pulse supplier.

Delivery systems according to double-supply approach may permit using them in applications that require supplying laser pulse(s) or pulse train(s) to two end-components. For example, such delivery systems may be ideal to implement radiation-based applications requiring a radiation emitter and a radiation receiver. Particular applications of this type may be the ones based on THz radiations aimed at, e.g., inspecting materials or objects with the aim of detecting thicknesses, holes, discontinuities, malformations, defects in general, etc.

According to double-supply implementations, the pulse producer may include a dual-output laser system configured to generate both the first low-power laser pulse and the second low-power laser pulse. Alternatively, the pulse producer may include a splitter configured to split a single or primary low-power laser pulse generated at the pulse producer into a first version and a second version of the single or primary low-power laser pulse, said first version corresponding to the first low-power laser pulse and said second version corresponding to the second low-power laser pulse, or vice versa.

Still according to double-supply approach, delivery systems may further comprise a synchronizer configured to synchronize the conveying of the first and second low-power laser pulses to each other. Such a synchronization may be based on time-adjusting the conveying of one of the first and second low-power laser pulses in such a way that, in use, the first and second high-power laser pulses respectively reach the first and second delivering ends with a predefined time difference between each other. The synchronizer may include a repetition rate controller configured to control or modulate a repetition rate of the first and second low-power laser pulses. Repetition rate controller may be integrated in systems with two synchronized lasers, and/or may use techniques such as ASOPS (Asynchronous Optical Sampling System) and/or ECOPS (Electronically Controlled Optical Sampling System). Alternatively, the synchronizer may include a mechanical delay line configured to time-adjust the conveying of one of the first and second low-power laser pulses. Mechanical delay line may thus be arranged at only one of the first and second optical fiber paths. Skilled person should know how this synchronization may be implemented depending on particular aimed application.

In examples, length of both first optical fiber path and second optical fiber path may be adjustable and/or tuneable by adding or reducing substantially same amount of optical fiber length.

Provider systems may also be provided herein for providing high-power laser pulses, said provider systems comprising one delivery system according to double-supply approach and another delivery system also according to double-supply approach. Such provider systems may thus correspond to what may be denominated quadruple-supply approach. Provider systems of any number of delivery systems according to double-supply approach may correspond to what may be denominated multiple-supply approach, which may be defined or obtained by extending same or similar principles as described for quadruple-supply approach. Accordingly, provider systems according to sextuple, octuple . . . n-tuple supply approach may also fall within the scope of present disclosure. Large number of (even unexpected) applications may be covered according to such multiple-supply approaches.

In examples according to what may be denominated double THz-supply approach, the first end-component may be a THz emitter and the second end-component may be a THz receiver, or vice versa, said THz emitter and THz receiver conforming a THz measurement header connectable with the delivery system. In particular, THz measurement systems may be provided comprising a delivery system according to the double THz-supply approach and the connectable THz measurement header connected with the delivery system.

According to what may be denominated quadruple THz-supply approach, supplying systems may be provided comprising a first delivery system according to the double THz-supply approach and a second delivery system also according to the double THz-supply approach. In particular, THz measuring systems may be provided including one of said supplying systems, the THz measurement header connectable with the first delivery system connected therewith, and the THz measurement header connectable with the second delivery system connected therewith. Same or similar considerations explained with respect to multiple-supply or n-tuple supply approach may be extrapolated to such THz-supply approaches.

In a further aspect, methods are provided of operating a delivery system (for delivering one or more high-power laser pulses) comprising a pulse producer and a first pulse supplier, the first pulse supplier including a first optical fiber path, a first pulse amplifier and a first delivering end, and the first pulse amplifier being arranged at a position along the first optical fiber path corresponding to a distal position relative to the pulse producer or proximal position relative to the first delivering end. Such methods of operating a delivery system comprise operating the pulse producer to produce a first low-power laser pulse having a power predefined to avoid or minimize deformation of the first low-power laser pulse along the first pulse supplier, the first low-power laser pulse being conveyed through an initial section of the first optical fiber path from the pulse producer to the first pulse amplifier. Said methods of operating a delivery system further comprise operating the first pulse amplifier to amplify the first low-power laser pulse to produce a first high-power laser pulse having a power predefined to operate a first end-component connectable with the first delivering end, the first high-power laser pulse being conveyed through a final section of the first optical fiber path from the first pulse amplifier to the first delivering end.

In a still further aspect, computer programs are provided comprising program instructions for causing a system or computing system to perform methods of operating a delivery system for delivering one or more high-power laser pulses, such as those described in other parts of the disclosure. These computer programs may be embodied on a storage medium and/or carried on a carrier signal.

In a yet further aspect, computing systems are provided for operating a delivery system for delivering one or more high-power laser pulses, said computing systems comprising a memory and a processor, embodying instructions stored in the memory and executable by the processor, and the instructions comprising functionality or functionalities to execute methods of operating a delivery system, such as those described in other parts of the disclosure.

### BRIEF DESCRIPTION OF THE DRAWINGS

Non-limiting examples of the disclosure will be described in the following, with reference to the appended drawings, in which:

FIG. 1 is a block diagram schematically illustrating delivery systems for delivering one or more high-power laser pulses according to examples.

FIG. 2 is a block diagram schematically illustrating delivery systems for delivering one or more high-power laser pulses according to further examples.

FIG. 3 is a block diagram schematically illustrating delivery systems for delivering one or more high-power laser pulses according to still further examples.

FIG. 4 is a block diagram schematically illustrating delivery systems for delivering one or more high-power laser pulses according to yet further examples.

FIG. 5 is a block diagram schematically illustrating delivery systems for delivering one or more high-power laser pulses according to furthermore examples.

FIG. 6 is a block diagram schematically illustrating delivery systems for delivering one or more high-power laser pulses according to still furthermore examples.

FIG. 7 is a flow chart schematically illustrating methods of operating a delivery system for delivering one or more high-power laser pulses according to examples.

### DETAILED DESCRIPTION OF EXAMPLES

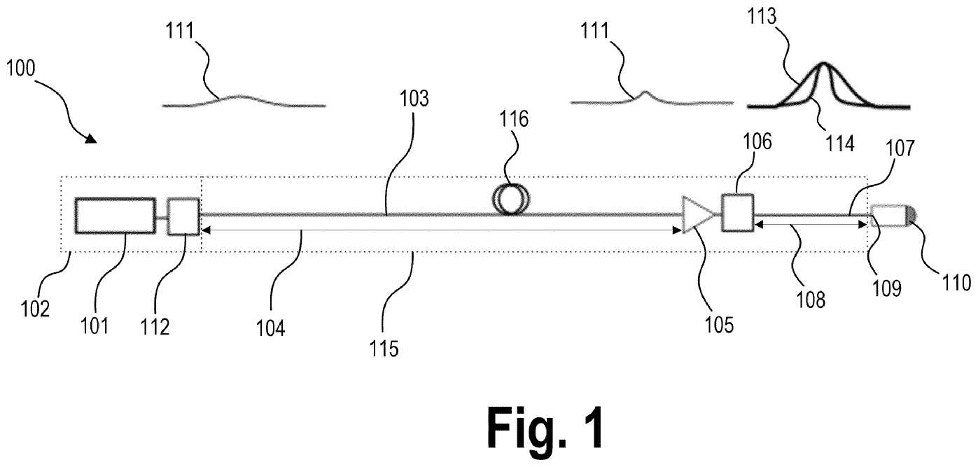

FIG. 1 is a block diagram schematically illustrating delivery systems 100 for delivering one or more high-power laser pulses 114 according to examples. As generally shown in the figure, delivery systems 100 may include several modules or units, or groups of modules or units, such as a pulse producer 102 and a first pulse supplier 115. The first pulse supplier 115 may include various modules or units such as a first optical fiber path 103, 107 covering a first length 104, 108, a first pulse amplifier 105 and a first delivering end 109. Delivery systems 100 may correspond to single-supply approach in the sense that only one high-power laser pulse (or pulses train) is deliverable or delivered.

The first optical fiber path 103, 107 may include initial optical fiber section 103 connecting pulse producer 102 and pulse amplifier 105 and final optical fiber section 107 connecting pulse amplifier 105 and first delivering end 109. The first pulse amplifier 105 may be arranged at a position along the first optical fiber path 103, 107 corresponding to a distal position relative to the pulse producer 102 or proximal position relative to the first delivering end 109. In other words, the first pulse amplifier 105 may be arranged at a position very much closer to the first delivering end 109 than to the pulse producer 102.

The pulse producer 102 may include a laser pulse generator 101 configured to produce a first low-power laser pulse 111 having a power predefined to avoid or minimize deformation of the first low-power laser pulse 111 along the first pulse supplier 115. As illustrated, first low-power laser pulse 111 is to be propagated (with low-power) most of the first optical fiber path 103, 107 thanks to the proximal position of the first pulse amplifier 105 with respect to the first delivering end 109. Ideally, the predefined power of the first low-power laser pulse 111 may be as low as possible taking into account, e.g., a minimum power at which module(s) or unit(s) conforming the pulse producer 102 and/or the first pulse supplier 115 may operate. Initial optical fiber section 103 of the first optical fiber path may be configured to convey the first low-power laser pulse 111 (from the pulse producer 102 to the first pulse amplifier 105) with purposed slight or negligible deformation thereof thanks to the predefined low-power aimed at that, even though first low-power laser pulse 111 is to travel substantially long distance 104.

The first pulse amplifier 105 may be configured to amplify the first low-power laser pulse 111 to produce a first high-power laser pulse 113 having a power predefined to operate a first end-component 110 connectable with the first delivering end 109. It is known the pulse power that may be needed by any given end-component 110 to be operated and, hence, also the amplification from low-power to high-power to be performed by the first pulse amplifier 105, so no details about this matter are provided herein. For example, the first pulse amplifier 105 may be configured to amplify the power of the first low-power laser pulse 111 between 5 and 10 times, or between 10 and 20 times, or according to any other suitable ratio depending on the first end-component 110 to be operated. Final optical fiber section 107 of the first optical fiber path may be configured to convey the first high-power laser pulse 113 from the first pulse amplifier 105 to the first delivering end 109, with slight or negligible or minimized deformation 114 of the first high-power laser pulse 113 thanks to at least the proximal position of the first pulse amplifier 105 with respect to the first delivering end 109. The first delivering end 109 may be configured to deliver the first high-power laser pulse 113 to the first end-component 110 when connected therewith.

Delivery systems 100 may further comprise other modules or units such as, e.g., a first pulse conditioner which may comprise one or more conditioner modules 112, 106. Conditioner module 112 may be associated or coupled with or included in the pulse producer 102 and configured to modify or condition the first low-power laser pulse 111 to compensate for dispersion and/or nonlinearity effects due to its conveying through the initial optical fiber section 103 with known and defined length 104. In the particular scenario illustrated, first low-power laser pulse 111 is shown at the output of the conditioner module 112 broader than at the input of the first pulse amplifier 105. With this, it is intended to indicate that the conditioner module 112 may expressly modify or condition the first low-power laser pulse 111 in such a way that dispersion and/or non-linearity effects due to optical fiber path 103 (with known and defined length 104) causes the first low-power laser pulse 111 to result with proper minimal or optimal specs (e.g., width) at the input of the first pulse amplifier 105. These proper minimal or optimal specs may be pursued and provoked in the mentioned manner for the first pulse amplifier 105 to perform minimally or optimally.

Conditioner module 106 may be associated or coupled with or included in the first pulse amplifier 105 and configured to modify or condition the first high-power laser pulse 113 to compensate for dispersion and/or nonlinearity effects due to its conveying through the final optical fiber section 107. In the particular scenario depicted, two versions or occurrences of the first high-power laser pulse 113, 114 are shown. Pulse occurrence 113 corresponds to the one outputted by conditioner module 112 and pulse occurrence 114 corresponds to the one received at the first delivering end 109. Pulse occurrence 113 is shown broader than pulse occurrence 114. This difference in width intends to reflect that the conditioner module 106 may expressly modify or condition the first high-power laser pulse 113 in such a way that dispersion and/or non-linearity effects due to optical fiber path 107 (with known and defined length 108) causes the first high-power laser pulse 114 to result with proper minimal or optimal specs (e.g., width) at the first delivering end 109. These proper minimal or optimal specs may be pursued and provoked in the mentioned manner for the first end-component 110 to perform minimally or optimally.

Conditioner module(s) or unit(s) may uniquely or additionally be arranged at any point of the first optical fiber path 103, 107 with same purpose of compensating for dispersion and/or nonlinearity effects. Any pulse conditioning, such as the ones described herein, may be mainly purposed for the first high-power laser pulse 114 to reach the first delivering end 109 satisfying minimal operational specs of the first end-component 110. It is known how laser pulse(s) may be conditioned depending on the optical fiber path and/or components (in the first pulse supplier 115) to be traversed or travelled by the laser pulse(s) and as required by first end-component 110, so no specific details about this are provided herein. In particular examples, conditioner module(s) arranged at the first optical fiber path 103, 107 may include an optical fiber portion with dispersion parameter opposite to dispersion parameter of all or part of remaining optical fiber in the first optical fiber path 103, 107. First end-component 110 may be a THz-based component such as, e.g., a THz emitter or a THz receiver which may require proper laser pulses (or pulses train) to operate.

The initial optical fiber section 103 or the final optical fiber section 107 or both (in the first optical fiber path) may have an oversized length for a plurality of intended (or even unexpected) applications of the delivery system 100. In particular, the initial optical fiber section 103 or the final optical fiber section 107 or both may be retractable and extensible, or rollable and unrollable. This manner, length 104 of first section 103 may be adaptable to an intended or desired distance between pulse producer 102 (with or without conditioner module 112) and first pulse amplifier 105, and/or length 108 of second section 107 may be adaptable to an intended or desired distance between first pulse amplifier 105 (with or without conditioner module 106) and first delivering end 109. Delivery systems 100 may require larger or smaller length of initial optical fiber section 103 and/or of final optical fiber section 107 due to, e.g., larger or smaller size of the object to be inspected in radiation-based applications. Inspection of aircrafts may require larger lengths than cars or motorbikes, for example. With the suggested adaptable overlength approaches, same delivery system 100 may be used in different applications in very flexible and versatile manner. In particular examples according to FIG. 1, only the initial optical fiber section 103 is shown oversized with leftover fiber path rollable/rolled 116. Ideally, leftover fiber may be rolled 116 at a proximal position with respect to the pulse producer 102 in order to keep it protected in, e.g., a cabinet hosting the pulse producer 102.

The first low-power laser pulse 111 and the first high-power laser pulse 113, 114, whose representation in the drawing are schematic temporal pulse traces (obtained with, e.g., an autocorrelator), may be femtosecond laser pulses. Minimal specs to be fulfilled at delivering point 109 for connectable end-component 110 to perform properly may include, e.g., pulse duration between 50 fs and 150 fs, and/or pulse wavelength between 1500 nm and 1600 nm, etc. In examples, all or part of the first optical fiber path 103, 107 may be polarization maintaining to minimize polarization-related dispersion effects.

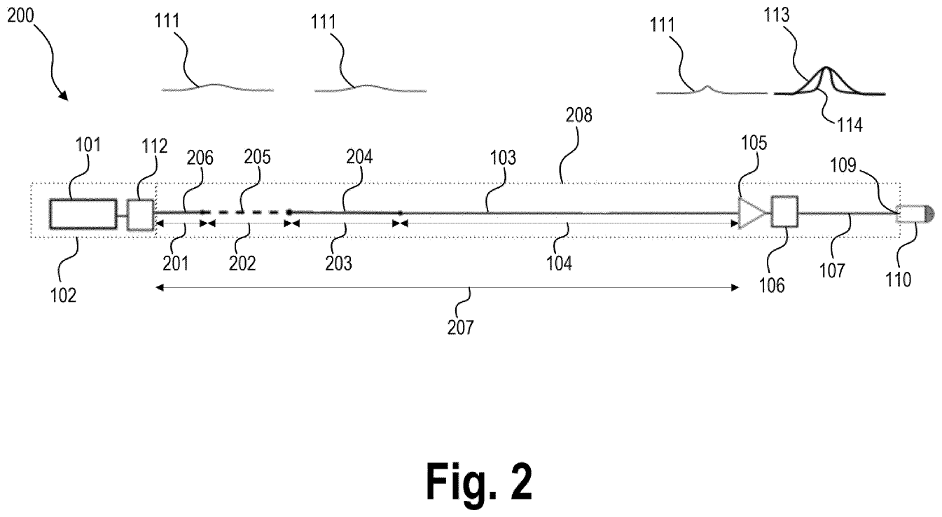

FIG. 2 is a block diagram schematically illustrating delivery systems 200 for delivering one or more high-power laser pulses according to further examples. FIG. 2 is similar to FIG. 1 with a difference of further including a free dispersion fiber section. Number references identifying same or similar elements from FIG. 1 may be reused in FIG. 2 and in following description thereof. Delivery systems 200 may also correspond to single-supply approach in the sense that only one high-power laser pulse (or pulses train) is delivered. Delivery systems 200 may include same or similar pulse producer 102 as the one of FIG. 1 and first pulse supplier 208 may be different from first pulse supplier 115 of FIG. 1. It is represented in the drawing that fiber section 103 may be extendable (and, if needed or desired, accordingly extended or lengthened) by, e.g., including or aggregating thereto a free dispersion fiber section including fiber portions having dispersion parameters opposite to each other. In the particular examples shown, length 104 of the fiber section 103 has been extended to longer length 207 by adding extra fiber sections 204, 205 and 206. As depicted, longer length 207 may result from summing length 104 (of the fiber section 103) and lengths 201-203 (of the fiber sections 206, 205 and 204, respectively). In order to make this fiber extension non-dispersive, fiber sections 204, 206 may have a dispersion parameter and fiber section 205 may have another dispersion parameter opposite to the one of sections 204, 206. This manner, based on choosing proper lengths 201-203, dispersion due to fiber sections 204, 206 and dispersion due to fiber section 205 may be compensated for each other in such a way that dispersion of whole added fiber portion 204-206 may be zero or negligible. Unlike in FIG. 1, first low-power laser pulse 111 is shown in FIG. 2 twice with substantially same width when conveyed through optical fiber portions 206, 205 and 204 conforming the free dispersion fiber section used to elongate the original optical fiber section 103.

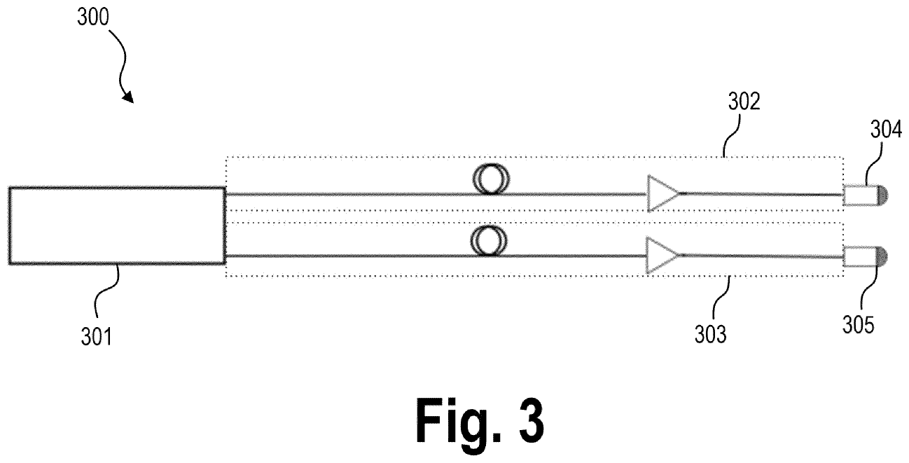

FIG. 3 is a block diagram schematically illustrating delivery systems 300 for delivering one or more high-power laser pulses according to still further examples. Such delivery systems 300 may correspond to what is denominated herein as double-supply approach in the sense that two (first and second) high-power laser pulses (or pulses trains) are separately delivered to respective end-components 304, 305. Such end-components 304, 305 may be, e.g., a THz emitter and a THz receiver, respectively, forming what is known as a THz measurement header. Delivery systems 300 may comprise a single laser pulse producer 301 and two (first and second) pulse suppliers 302, 303 to supply corresponding (first and second) high-power laser pulses (or pulses trains) to respective connectable or connected (first and second) end-components 304, 305. Apparatus shown in this drawing may thus correspond to a THz-based measurement system according to double-supply approach. Pulse suppliers 302, 303 may have same or similar or compatible configuration aimed at supplying respective (first and second) high-power laser pulses (or pulses trains) to respective connectable or connected (first and second) end-components 304, 305 in proper manner so as to, e.g., operate corresponding THz measurement header. End-components 304 and 305 may be properly operated by providing first and second high-power laser pulses (or pulses trains) fulfilling corresponding minimal specs of said end-components 304 and 305.

Pulse producer 301 may be configured to produce first and second low-power laser pulses (to be conveyed and adjusted through respective first and second pulse suppliers 302, 303) according to either direct generation approach or split-based generation approach. Direct generation approach may be based on, e.g., a dual-output laser system (not shown) configured to directly generate both first and second low-power laser pulses. Split-based generation approach may be based on, e.g., a splitter (not shown) configured to split a single or primary low-power laser pulse (generated by, e.g., a laser pulse generator in the pulse producer) into first version and second version of the primary low-power laser pulse. Said first version may accordingly correspond to the first low-power laser pulse and second version to the second low-power laser pulse, or vice versa.

Delivery systems 300 may further comprise other modules such as, e.g., conditioner(s) (not shown), a synchronizer (not shown), etc. Synchronizer may be included in the pulse producer 301 and may be configured to synchronize the conveying of the first and second low-power laser pulses to each other. This synchronization may be performed in such a way that first and second high-power laser pulses respectively reach, in use, first and second delivering ends 304, 305 with a predefined time difference between each other. Synchronizer may include, e.g., a repetition rate controller or, alternatively, a mechanical delay line. The repetition rate controller may be configured to control or modulate a repetition rate of the first and second low-power laser pulses. The mechanical delay line may be configured to time-adjust the conveying of one of the first and second low-power laser pulses with respect to the other.

Since performance of delivery systems according to double-supply approach may depend on simultaneous fulfilment of first and second end-components' minimal specs, optimal performance may be more difficult to achieve than in the case of delivery systems according to single-supply approach. However, in same manner as for single supply approach, implementations according to double-supply approach may also minimize intrinsic dispersion and nonlinear effects based on propagation of low-power laser pulses along most part of corresponding optical fiber paths.

A new scenario is thus provided, which may help to deploy technology in industrial context requiring both precision and long optical fiber path distances. For example, a THz system for controlling layer thickness of car body coatings may normally require distances of more than 30 meters and precisions in the range of one micrometre. Such a THz system could be implemented using low-power optical fiber path's length of around >20 meters and (consequently) high-power optical fiber path's length of around <10 meters. Delivery systems according to present disclosure may enable to supply optical pulses with optimal or minimal specs at corresponding THz antennas with long-distance propagation of laser pulses under proper performance and precision conditions.

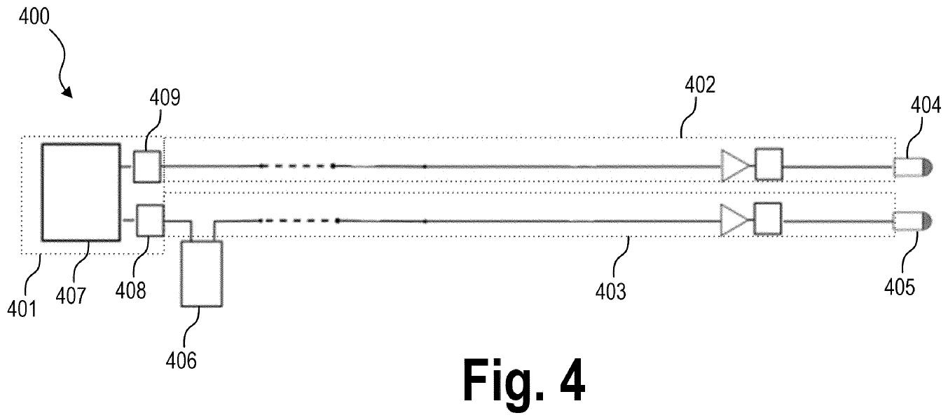

FIG. 4 is a block diagram schematically illustrating delivery systems 400 for delivering one or more high-power laser pulses according to yet further examples. The particular examples represented also correspond to the double-supply approach, since they may be configured to operate two connectable (or connected if desired) end-components 404, 405 (forming, e.g., a THz measurement header). In the illustrated scenario, synchronizer 406 may be provided outside pulse producer 401 which may be similar to pulse producer 102 of FIGS. 1 and 2 with a difference in that pulse producer 401 may output two laser pulses instead of one. Pulse producer 401 may thus include pulse generator 407 configured to generate first and second low-power laser pulses and, in some examples, first and second conditioner modules 408, 409 to properly condition first and second low-power laser pulses, respectively. First and second pulse suppliers 402, 403 included in delivery systems 400 may also be same or similar as pulse suppliers described in other parts of the disclosure. In the particular examples illustrated, pulse suppliers 402, 403 may be same or similar as the one of FIG. 2. As depicted, synchronizer 406 may be configured to time-adjust the conveying of one of the first and second low-power laser pulses through pulse supplier 403 in order to cause a predefined time difference between the one and the other conveying.

The possibility of retrofitting a double-supply system, originally manufactured for certain original length, in order to cover an optical fiber path longer than its original length may offer further opportunities in industrial context. The retrofitting may be implemented by adding extra free dispersion optical fiber sections, as shown in pulse suppliers 402, 403. In order to accurately describe advantages of delivery systems 400 according to double-supply, following THz-based example may be assumed. THz measuring system for controlling layer thickness of car body coatings in a factory manufacturing compact and mid-size vehicles was initially designed and manufactured to cover maximum expected distance of, e.g., 20 meters. However, the factory began to manufacture larger vehicles requiring a new distance of, e.g., 30 meters or more, so it was decided to retrofit the original system to adapt it to the new scenario.

FIG. 4 shows particular retrofittable implementations 400 according to present disclosure. The pulse producer 401 may output two low-power laser pulses through first and second optical fiber paths in respective pulse suppliers 402, 403. Conditioner modules 409, 408 at pulse producer 401 may compensate for dispersion and nonlinear effects of the optical propagation through low-power sections of first and second optical fiber paths (in pulse suppliers 402, 403). Synchronization may be implemented by a mechanical delay unit 406 at second optical fiber path (in pulse supplier 403). This implementation may correspond to a TDS-THz system, wherein first end-component 404 is a THz emitter antenna and second end-component 405 is a THz receiver/detector antenna.

As depicted, two free dispersion fiber sections may be included in low power sections of both first and second optical fiber paths (in pulse suppliers 402, 403). Both extra free dispersion fiber sections may have same length to make the lengths of the first and second optical fiber paths to match. Even though the modules in pulse producer 401 and pulse suppliers 402 and 403 were originally manufactured and adjusted properly to nominal specs of the original system, slight but possibly significant mistunes could emerge in high-power laser pulses at the antennas 404, 405.

Advantages of delivery systems 400 may permit keeping dispersion and nonlinear effects under admissible levels and balanced between each other. For example, if mistunes are expressed in pulse duration slightly different from (minimal or optimal) specs of antennas 404, 405, the magnitude and sense of that difference may be balanced and/or approximately the same in both antennas 404, 405. This is an important advantage in comparison with prior art THz systems working at long distances, in which dispersion and nonlinearities may affect laser pulses through first and second pulse suppliers 402, 403 in a more uncontrolled or unbalanced or different way. In delivery systems 400, differences in, e.g., pulse duration, may be adjusted or tuned by changing patch cords lengths of the first and second optical fiber paths (in pulse suppliers 402, 403), by enlarging or shortening in same or similar amount of length.

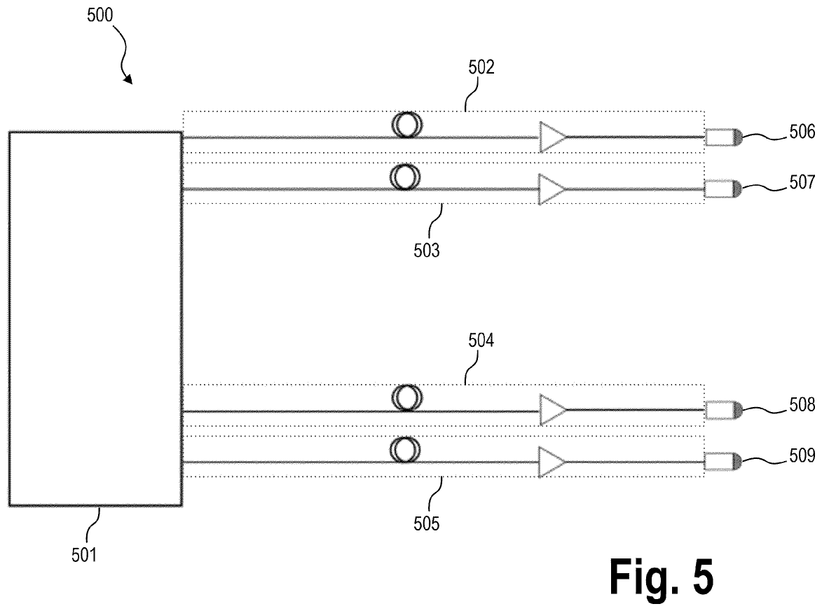

FIG. 5 is a block diagram schematically illustrating delivery systems 500 for delivering one or more high-power laser pulses according to furthermore examples. The particular examples represented may correspond to what may be denominated quadruple-supply approach, since they may be configured to operate four connectable (or connected if desired) end-components 506-509. End-components 506 and 507 may form a first THz measurement header, and end-components 508 and 509 may conform a second THz measurement header. Apparatus shown in this drawing may thus correspond to a THz-based measurement system according to quadruple-supply approach or, in other words, double-header approach. Delivery systems 500 may comprise a pulse producer 501 with same or similar configuration as other pulse producers described herein with a difference in that pulse producer 501 may output four low-power laser pulses instead of one or two. Delivery systems 500 may comprise two delivery systems according to double-supply approach such as the ones of FIGS. 3 and 4. In the particular examples illustrated, pulse suppliers 502-505 may be same or similar as the ones of FIG. 3. Delivery systems configured to supply more than four high-power laser pulses (or pulses trains) to more than four end-components, respectively, may also be provided based on principles underlying the examples of FIG. 5 or any other similar examples described herein. Delivery systems according to double-header or triple-header or quadruple-header or, in general, multiple-header approach may permit providing THz-based measurement systems with several or many THz measurement headers to contactless inspect or analyse different parts of same object or different objects simultaneously.

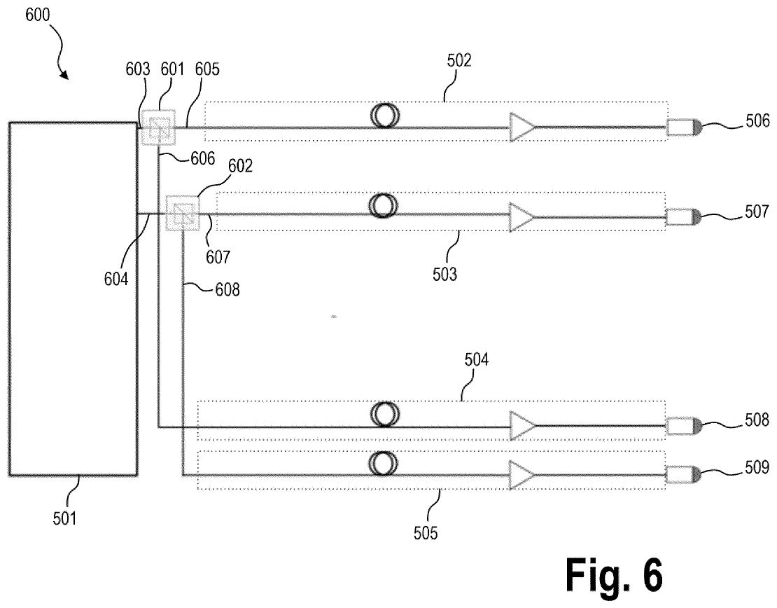

FIG. 6 is a block diagram schematically illustrating delivery systems 600 for delivering one or more high-power laser pulses according to still furthermore examples. FIG. 6 is similar to FIG. 5 and, therefore, number references identifying same or similar elements from FIG. 5 may be reused in FIG. 6 and in following description thereof. A difference of FIG. 6 with respect to FIG. 5 may reside in how low-power laser pulses (or pulses trains) may be generated for their provision to corresponding pulse suppliers 502-505 to operate pertinent end-components 506-509. Pulse producer 501 may be similar to the one of FIG. 5 but, in the case of FIG. 6, is configured to output two low-power laser pulses 603, 604 instead of four. A splitter 601 may be configured or arranged to split low-power laser pulse 603 into first version/branch 605 and second version/branch 606 of the low-power laser pulse 603, said first version/branch 605 to be provided to pulse supplier 502 and said second version/branch 606 to be provided to pulse supplier 504. Another splitter 602 may be configured or arranged to split low-power laser pulse 604 into first version/branch 607 and second version/branch 608 of the low-power laser pulse 604, said first version/branch 607 to be provided to pulse supplier 503 and said second version/branch 608 to be provided to pulse supplier 505. With this configuration, only one of the low-power laser pulses 603, 604 outputted by the pulse producer 501 may be time-adjusted with respect to the other of the low-power laser pulses 603, 604 at the pulse producer 501 itself. Apparatus shown in this drawing may similarly correspond to a THz-based measurement system according to quadruple-supply approach or, in other words, double-header approach. Delivery systems configured to supply more than four high-power laser pulses (or pulses trains) to more than four end-components, respectively, may also be provided based on principles underlying the examples of FIG. 6 or any other similar examples described herein.

As used herein, the term “module” or “unit” may be understood to refer to software, firmware, hardware and/or various combinations thereof. It is noted that the modules are exemplary. The modules may be combined, integrated, separated, and/or duplicated to support various applications. Also, a function described herein as being performed by a particular module may be performed by one or more other modules and/or by one or more other devices instead of or in addition to the function performed by the described particular module.

The modules may be implemented across multiple devices, associated or linked to corresponding delivery systems for delivering one or more high-power laser pulses proposed herein, and/or to other components that may be local or remote to one another. Additionally, the modules may be moved from one device and added to another device, and/or may be included in both devices, associated to corresponding delivery systems for delivering one or more high-power laser pulses proposed herein. Any software implementations may be tangibly embodied in one or more storage media, such as e.g. a memory device, a floppy disk, a compact disk (CD), a digital versatile disk (DVD), or other devices that may store computer code.

Delivery systems for delivering one or more high-power laser pulses according to present disclosure may be implemented by computing means, electronic means or a combination thereof. The computing means may be a set of instructions (e.g. a computer program) and then delivery systems for delivering one or more high-power laser pulses may comprise a memory and a processor, embodying said set of instructions stored in the memory and executable by the processor. These instructions may comprise functionality or functionalities to execute corresponding methods of operating a delivery system such as e.g. the ones described with reference to some figures.

In case the delivery systems for delivering one or more high-power laser pulses are implemented only by electronic means, a controller of the system may be, for example, a CPLD (Complex Programmable Logic Device), an FPGA (Field Programmable Gate Array) or an ASIC (Application-Specific Integrated Circuit).

In case the delivery systems for delivering one or more high-power laser pulses are a combination of electronic and computing means, the computing means may be a set of instructions (e.g. a computer program) and the electronic means may be any electronic circuit capable of implementing corresponding steps of the delivery methods for delivering one or more high-power laser pulses proposed herein, such as those described with reference to other figures.

The computer program(s) may be embodied on a storage medium (for example, a CD-ROM, a DVD, a USB drive, a computer memory or a read-only memory) or carried on a carrier signal (for example, on an electrical or optical carrier signal).

The computer program(s) may be in the form of source code, object code, a code intermediate source and object code such as in partially compiled form, or in any other form suitable for use in implementing delivery systems for delivering one or more high-power laser pulses according to present disclosure. The carrier may be any entity or device capable of carrying the computer program(s).

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program(s) is (are) embodied in a signal that may be conveyed directly by a cable or other device or means, the carrier may be constituted by such a cable or other device or means. Alternatively, the carrier may be an integrated circuit in which the computer program(s) is (are) embedded, the integrated circuit being adapted for performing, or for use in the performance of, delivery methods for delivering one or more high-power laser pulses proposed herein.

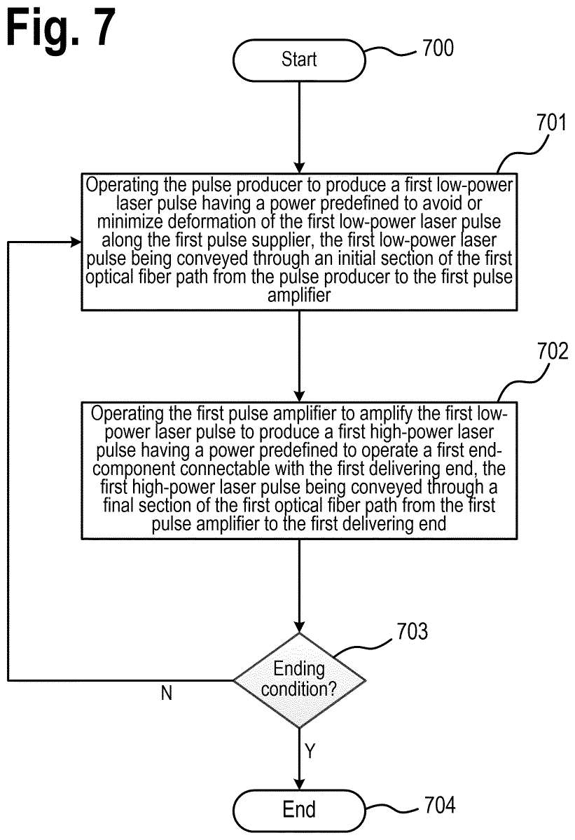

FIG. 7 is a flow chart schematically illustrating methods of operating a delivery system such as the ones of FIGS. 1 and 2. Such methods of operating a delivery system may be also denominated herein operating methods. As generally shown in the figure, operating methods may be initiated (e.g. at block 700) upon detection of a starting condition such as, e.g., a request for starting the method or the like. Since operating methods according to FIG. 7 are performable to control or operate delivery systems according to FIGS. 1 and 2, number references from FIGS. 1 and 2 may be reused in the following description of FIG. 7.

Operating methods may further include (e.g. at block 701) operating the pulse producer 102 to produce a first low-power laser pulse (or pulses train) having a power predefined to avoid or minimize deformation of the first low-power laser pulse (or pulses train) along the first pulse supplier 115, 209, the first low-power laser pulse (or pulses train) being conveyed through an initial section 103, 208 of the first optical fiber path from the pulse producer 102 to the first pulse amplifier 105. This functionality implemented or implementable at block 701 may be performed to operate, e.g., the pulse producer 102 previously described with reference to FIGS. 1 and 2. Functional details, considerations and principles explained about said pulse producer 102 may thus be similarly attributed or attributable to method block 701.

Operating methods may further include (e.g. at block 702) operating the first pulse amplifier 105 to amplify the first low-power laser pulse to produce a first high-power laser pulse having a power predefined to operate a first end-component 110 connectable with the first delivering end 109, the first high-power laser pulse being conveyed through a final section 107 of the first optical fiber path from the first pulse amplifier 105 to the first delivering end 109. This functionality implemented or implementable at block 702 may be performed to operate, e.g., the pulse amplifier 105 previously described with reference to FIGS. 1 and 2. Functional details, considerations and principles explained about said pulse amplifier 105 may thus be similarly attributed or attributable to method block 702.

Operating methods may still further include (e.g. at decision block 703) verifying whether an ending condition is satisfied, in which case, Y, the method may be terminated by, e.g., transitioning to ending block 704 and, otherwise, N, a new iteration of the method may be initiated by, e.g., looping back to block 701 so as to produce next first low-power laser pulse (or pulses train). Ending condition may include, e.g., reception of a user termination request or the like.

Operating methods according to FIG. 7 are suitable to operate delivery devices according to single-supply approach, but they are clearly extendable to operate delivery devices according to multiple-supply approach based on functional principles described herein with respect to operating methods themselves and delivery devices operable by said methods. For example, elements other than pulse producer and pulse amplifier, such as e.g. synchronizer and/or conditioner, may be operated by operating methods based on functional principles described herein with respect to synchronizer and/or conditioner, respectively.

Although only a number of examples have been disclosed herein, other alternatives, modifications, uses and/or equivalents thereof are possible. Furthermore, all possible combinations of the described examples are also covered. Thus, the scope of the disclosure should not be limited by particular examples, but it should be determined only by a fair reading of the claims that follow.

What is claimed is:

1-28. (canceled)

29. A delivery system for delivering one or more high-power laser pulses, the delivery system comprising a pulse producer and a first pulse supplier, the first pulse supplier including a first optical fiber path, a first pulse amplifier and a first delivering end; wherein:
the pulse producer is configured to produce a first low-power laser pulse having a power predefined to avoid or minimize deformation of the first low-power laser pulse along the first pulse supplier;
an initial section of the first optical fiber path is configured to convey the first low-power laser pulse from the pulse producer to the first pulse amplifier;
the first pulse amplifier is configured to amplify the first low-power laser pulse to produce a first high-power laser pulse having a power predefined to operate a first end-component connectable with the first delivering end;
a final section of the first optical fiber path is configured to convey the first high-power laser pulse from the first pulse amplifier to the first delivering end; and
the first pulse amplifier is arranged at a position along the first optical fiber path corresponding to a distal position relative to the pulse producer or proximal position relative to the first delivering end.

30. The delivery system according to claim 29, further comprising a first pulse conditioner configured to modify or condition the first low-power laser pulse or the first high-power laser pulse or both to compensate for dispersion and/or nonlinearity effects of the first pulse supplier, the first pulse conditioner being included in the pulse producer or in the first pulse amplifier or in the first optical fiber path.

31. The delivery system according to claim 30, wherein the first pulse conditioner is comprised in the first optical fiber path and includes an optical fiber portion with a dispersion parameter opposite to a dispersion parameter of all or part of remaining optical fiber in the first optical fiber path.

32. The delivery system according to claim 29, wherein the initial section or the final section or both of the first optical fiber path have an oversized length for a plurality of intended applications of the delivery system.

33. The delivery system according to claim 29, wherein the initial section of the first optical fiber path is extendable by including or aggregating therein a free dispersion fiber section including fiber portions having dispersion parameters opposite to each other.

34. The delivery system according to claim 29, further comprising a second pulse supplier including a second optical fiber path, a second pulse amplifier and a second delivering end; wherein:
the pulse producer is further configured to produce a second low-power laser pulse having a power predefined to avoid or minimize deformation of the second low-power laser pulse along the second pulse supplier;
an initial section of the second optical fiber path is configured to convey the second low-power laser pulse from the pulse producer to the second pulse amplifier;
the second pulse amplifier is configured to amplify the second low-power laser pulse to produce a second high-power laser pulse having a power predefined to operate a second end-component connectable with the second delivering end;
a final section of the second optical fiber path is configured to convey the second high-power laser pulse from the second pulse amplifier to the second delivering end; and
the second pulse amplifier is arranged at a position along the second optical fiber path corresponding to a distal position relative to the pulse producer or proximal position relative to the second delivering end.

35. The delivery system according to claim 34, wherein the second pulse supplier has same configuration as the first pulse supplier.

36. The delivery system according to claim 34, wherein the pulse producer includes a dual-output laser system configured to generate both the first low-power laser pulse and the second low-power laser pulse.

37. The delivery system according to claim 34, wherein the pulse producer includes a splitter configured to split a single low-power laser pulse generated at the pulse producer into a first version and a second version of the single low-power laser pulse, said first version corresponding to the first low-power laser pulse and said second version corresponding to the second low-power laser pulse, or vice versa.

38. The delivery system according to claim 34, further comprising a synchronizer configured to synchronize the conveying of the first and second low-power laser pulses to each other.

39. The delivery system according to claim 38, wherein the synchronizer is configured to synchronize the conveying of the first and second low-power laser pulses to each other based on time-adjusting the conveying of one of the first and second low-power laser pulses in such a way that, in use, the first and second high-power laser pulses respectively reach the first and second delivering ends with a predefined time difference between each other.

40. The delivery system according to claim 38, wherein the synchronizer includes a repetition rate controller configured to control or modulate a repetition rate of the first and second low-power laser pulses, and/or a mechanical delay line configured to implement the time-adjusting of the conveying of one of the first and second low-power laser pulses.

41. The delivery system according to claim 34, wherein the first end-component is a THz emitter and the second end-component is a THz receiver, or vice versa, said THz emitter and THz receiver conforming a THz measurement header connectable with the delivery system.

42. The THz measurement system comprising a delivery system according to claim 41 and the THz measurement header connectable with the delivery system connected therewith.

43. A provider system for providing high-power laser pulses, comprising two delivery systems, both according to claim 34.

44. A supplying system for supply of high-power laser pulses, comprising two delivery systems, both according to claim 41.

45. A THz measuring system including a supplying system according to claim 44, the THz measurement header connectable with the first delivery system connected therewith, and the THz measurement header connectable with the second delivery system connected therewith.

46. A method of operating a delivery system for delivering one or more high-power laser pulses, the delivery system comprising a pulse producer and a first pulse supplier, the first pulse supplier including a first optical fiber path, a first pulse amplifier and a first delivering end, wherein
the first pulse amplifier is arranged at a position along the first optical fiber path corresponding to a distal position relative to the pulse producer or proximal position relative to the first delivering end, and wherein the method comprises:
operating the pulse producer to produce a first low-power laser pulse having a power predefined to avoid or minimize deformation of the first low-power laser pulse along the first pulse supplier, the first low-power laser pulse being conveyed through an initial section of the first optical fiber path from the pulse producer to the first pulse amplifier; and
operating the first pulse amplifier to amplify the first low-power laser pulse to produce a first high-power laser pulse having a power predefined to operate a first end-component connectable with the first delivering end, the first high-power laser pulse being conveyed through a final section of the first optical fiber path from the first pulse amplifier to the first delivering end.

47. A computer program comprising program instructions for causing a computing system to perform a method according to claim 46 of operating a delivery system for delivering one or more high-power laser pulses.

48. A computing system for operating a delivery system for delivering one or more high-power laser pulses, the computing system comprising a memory and a processor, embodying instructions stored in the memory and executable by the processor, the instructions comprising functionality to execute a method according to claim 46 of operating a delivery system for delivering one or more high-power laser pulses.
